(19) United States
(12) Patent Application Publication
(10) Pub. No.: US 2006/0237031 A1
(43) Pub. Date: Oct. 26, 2006

(54) APPARATUS AND METHOD FOR TREATING SUBSTRATE

(75) Inventor: Hun-Jung Yl, Gyeonggi-do, (KR)

Correspondence Address: MARGER JOHNSON & MCCOLLOM, P.C., 210 SW MORRISON STREET, SUITE 400, PORTLAND, OR, 97204, US

(73) Assignee: Samsung Electronics Co., Ltd., Suwon-si (KR)

(21) Appl. No.: 11/379,686

(22) Filed: Apr. 21, 2006

(30) Foreign Application Priority Data
Apr. 22, 2005 (KR) 2005-33575

(51) Int. Cl. B08B 3/10

(52) U.S. Cl. 134/1.3; 134/34; 134/36; 134/198; 134/902

(57) ABSTRACT

In an embodiment, an apparatus and method for cleaning a wafer include a container containing deionized water, and a cover opening/closing an opened upper portion of the container. A nozzle is installed in the cover to spray the deionized water to a space defined by the cover. A first electrode and a second electrode are formed in a plate shape disposed below the nozzle, The first electrode and the second electrode are arranged to face each other and are spaced apart so that an electric field is formed therebetween. When the deionized water in a mist state passes through the space where the electric field is formed, water molecules dissociate into ions and radicals. Since the cleaning of a wafer is achieved by the activated deionized water, environment pollution caused by the use of a chemical solution can be prevented.

### BACKGROUND OF THE INVENTION

This U.S. non-provisional patent application claims priority under 35 U.S.C. §119 of Korean Patent Application No. 2005-33575 filed on Apr. 22, 2005, the entire contents of which are hereby incorporated by reference.

1. Field of the Invention

The present invention relates to an apparatus and method for treating a semiconductor substrate, and more particularly, to an apparatus and method for performing a predetermined process on a wafer by using a processing solution.

2. Description of the Related Art

Generally, semiconductor devices are fabricated by repeating various unit processes, such as deposition, photolithography, etching, polishing, and cleaning. During these unit processes, the cleaning process removes residual chemicals, small particles, and contaminants, which are attached to the surface of a semiconductor wafer, and also removes unnecessary layers. The importance of the cleaning process generally increases as patterns are formed more finely on a wafer.

The cleaning process typically includes a chemical-solution treatment process, a rinsing process, and a drying process. The chemical-solution treatment process uses a chemical solution to etch or strip contaminants, such as metallic contaminants, particles and organic matter, from the wafer by a chemical reaction. After the chemical-solution treatment process, the rinsing process uses deionized water to rinse the wafer. The drying process then removes the deionized water from the water.

To remove the remaining contaminants from the wafer, a cleaning solution is prepared by dissolving a chemical solution, such as ammonium hydroxide, fluoric acid, and sulfuric acid, in deionized water. The cleaning of the wafer is achieved by active species, such as hydroxyl ions, hydrogen ions, oxygen ions, and ozone ions. Among the active species, hydroxyl ions mainly influence the cleaning of the wafer, and hydrogen ions, oxygen ions, or ozone ions have an influence depending on the kinds of contaminants that are present.

In using the chemical solution, however, basic layers other than the ones targeted for cleaning may be etched by by-products instead of the active species that are intended to participate in the cleaning process. Also, the environment may be polluted by the use of the chemical solution. A lot of cost may be spent on the purchase of expensive chemical solutions and their disposal.

Preferably, a large amount of active species should be contained in the cleaning solution for improving the cleaning efficiency. For this purpose, one method is to heat the cleaning solution to a high temperature, or increase the concentration of the chemical solution. However, in the case of heating the cleaning solution, it takes much time to heat it and keep it warm. Also, heating components are additionally required and thus the maintenance is difficult. Meanwhile, in the case of increasing the concentration of the chemical solution, basic layers are rapidly etched due to the increased concentration of the by-products as well. Therefore, cleaning time cannot be lengthened and thus a satisfactory cleaning cannot be achieved.

In addition, preferably, hydrogen should be combined on the surface of the completely cleaned wafer to prevent the formation of a natural oxide layer when the wafer is exposed to air. When the wafer is cleaned with the deionized water after the wafer is rinsed in the chemical solution (e.g., fluoric acid), fluorine combined on the wafer is replaced by hydrogen. However, fluorine is mainly replaced by hydrogen ions, and the replacement rate is low. Consequently, even after the wafer is cleaned, a large amount of fluorine still remains in the combined state on the surface of the wafer.

Further, when the wafer is cleaned using the chemical solution, the rinsing process of removing the chemical solution from the wafer must be performed. Therefore, a lot of processes, including the chemical-solution treatment process, the rinsing process, and the drying process, are required to clean the wafer, an endeavor that takes much time.

### SUMMARY OF THE INVENTION

The present invention provides an apparatus and method for treating a substrate, capable of solving the problems that occur in a cleaning process using a chemical solution.

The present invention also provides an apparatus and method for treating a substrate, capable of increasing the number and kind of active species contained in a cleaning solution.

The present invention further provides an apparatus and method for treating a substrate, capable of making the surface of a wafer in a state of hydrogen bond after a chemical-solution treatment process and a rinsing process.

The present invention further yet provides an apparatus and method for treating a substrate, capable of reducing the time necessary for a cleaning process.

The present invention still further provides an apparatus and method for treating a substrate, capable of generating a large amount of various active species from a processing solution.

Embodiments of the present invention provide apparatuses for treating a substrate. The apparatus includes a processing chamber including a container in which at least one substrate is received and processes are performed on the substrate, and a processing solution supply pipe for supplying a processing solution to the processing chamber. An electric-field forming member may be installed in the processing chamber to activate the processing solution. The electric-field forming member includes a plurality of electrodes arranged spaced apart from one another to thereby define a space into which the processing solution is introduced, and a power source for applying a predetermined voltage to at least one of the electrodes to form an electric field in the space between the adjacent electrodes. Since the processing solution is activated by the electric field, a large amount of various active species are generated in the processing solution.

In further embodiments, the apparatus may be used for cleaning the substrate and the processing solution is a cleaning solution. The cleaning solution may be a deionized water. When the deionized water flows through the passage where the electric field is formed, a plurality of active species such as hydroxyl radicals, hydroxyl ions, hydrogen radicals and hydrogen ions, oxygen radicals and oxygen ions, and ozone radicals and ozone ions, are generated from the deionized water. Due to the active species contained in the deionized water, contaminants attached to the substrate are removed.

In other embodiments, the apparatus includes a mixing tank in which hydrogen (H₂) and oxygen (O₂) are dissolved in the deionized water before the deionized water is activated. A large amount of ions and radicals, which are efficient at removing the contaminants, is generated and contained in the deionized water, depending on an amount of contaminants to be removed from the substrate.

In yet other embodiments, the electrodes are formed in a plate shape and arranged in a horizontal direction. Since the electric field is formed in a relatively wide area, a large amount of the cleaning solution can be simultaneously activated. Therefore, the present embodiment is advantageous for a batch type cleaning apparatus requiring a large amount of the cleaning solution.

In further embodiments, the electric-field forming member includes a first electrode and a second electrode disposed below the first electrode. The second electrode is spaced apart from the first electrode, so that a space into which the cleaning solution is introduced is provided. Alternatively, the electric-field forming member further includes a third electrode opposing the first electrode with respect to the second electrode. The third electrode is spaced apart from the second electrode by a predetermined distance, whereby a space into which the processing solution is introduced is formed between the second electrode and the third electrode. By providing a plurality of spaces where the cleaning solution is activated, an amount of the active species increases.

The apparatus further includes a nozzle for spraying the processing solution toward the first electrode, the processing solution being supplied from the processing solution supply pipe. The first electrode includes a plurality of openings through which the processing solution sprayed from the nozzle is introduced to the space, and the second electrode includes a plurality of openings through which the activated processing solution is discharged to the container. The first electrode and the second electrode are formed in a mesh shape or a porous plate shape.

In other embodiments, the nozzle has a spray hole to supply the processing solution in a mist state. Since particles of the processing solution introduced into the space where the electric field is formed are fine, the generation of the active species in the space can increase.

In further embodiments, the surfaces of the electrodes are coated with an insulating material. Therefore, higher voltage can be applied without generating a spark. Therefore, the generation of the active species can increase and it is possible to prevent the active species from reacting with the electrodes.

Other embodiments of the present invention provide methods for treating a substrate. A plurality of electrodes are arranged to face one another in a vertical direction in a container where substrates are received, and a predetermined voltage is applied to the electrodes so that an electric field is formed in a space defined between the adjacent electrodes. Then, a processing solution used in a predetermined process is supplied to the space, and upon being activated in the space, is supplied to the container.

The predetermined process may be a process of cleaning the substrate and the processing solution may be a cleaning solution. Due to the use of such a cleaning solution, environment pollution can be prevented and cost may be reduced. Deionized water that can generate the active species required in the cleaning process may be used. To minimize the recombination of the active species before they are supplied to the cleaning chamber, the activation of the cleaning solution may be achieved in a region adjacent to the cleaning chamber.

In yet further embodiments, the method includes removing contaminants containing at least one of particles, organic matter, and metallic contaminants from the substrate, and drying the wafer. The removal of the contaminants from the substrate is achieved by the activated deionized water. The active species containing ions and radicals may be generated from the deionized water by forming an electric field in a passage through which the deionized water flows. Since the cleaning of the wafer is achieved without using a chemical solution, the operation of rinsing the substrate with the deionized water is unnecessary. Therefore, time necessary for the cleaning process can be reduced remarkably. Meanwhile, prior to the drying process, the cleaning process may be selectively preformed using the deionized water.

Further embodiments of the present invention provide a method for cleaning a substrate including removing contaminants from the substrate, rinsing the substrate, and drying the substrate. The removal of the contaminants from the substrate can be achieved using a chemical solution, and the rinsing of the substrate can be achieved using active species containing ions and radicals. The drying of the substrate can be achieved by various methods. After the rinsing process, hydrogen is mainly combined on the surface of the substrate. Therefore, it is possible to minimize the formation of a natural oxide layer on the substrate when the substrate is exposed to air.

### BRIEF DESCRIPTION OF THE DRAWINGS

The accompanying drawings, which are included to provide a further understanding of the invention, and are incorporated in and constitute a part of this application, illustrate embodiments of the invention and together with the description serve to explain the principle of the invention. In the drawings:

FIG. 1 is a cross-sectional view of a cleaning apparatus according to a preferred embodiment of the present invention;

FIG. 2 is a graph illustrating a dissociation energy of molecules and a dissociation and combination of water molecules;

FIGS. 3 and 4 are perspective views illustrating examples of a nozzle of FIG. 1;

FIGS. 5 and 6 are perspective views illustrating examples of electrodes;

FIG. 7 is a cross-sectional view of a cleaning apparatus according to another embodiment of the present invention;

FIG. 8 is a cross-sectional view of a cleaning apparatus according to a further embodiment of the present invention;

FIG. 9 is a cross-sectional view of a cleaning apparatus according to still a further embodiment of the present invention;

FIG. 10 illustrates a surface state of a wafer during a cleaning process using a general deionized water; and

FIG. 11 illustrates a surface state of a wafer during a cleaning process using deionized water containing a radical.

### DETAILED DESCRIPTION OF THE INVENTION

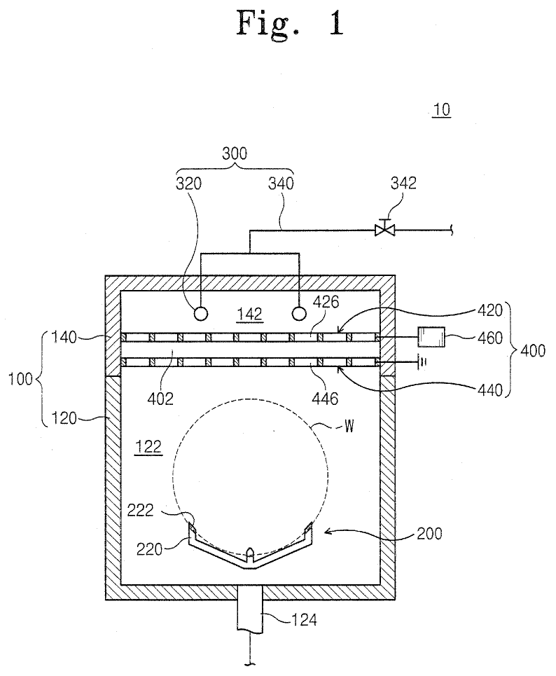

Embodiments of the present invention will now be described more fully with reference to FIGS. 1 through 11. The invention may, however, be embodied in many different forms and should not be construed as being limited to the embodiments set forth herein; rather, these embodiments are provided so that this disclosure will be thorough and complete, and will fully convey the concept of the invention to those skilled in the art. In the drawings, the thicknesses of layers and regions are exaggerated for clarity.

An apparatus for cleaning a semiconductor substrate such as a wafer (W) will be exemplarily described below. However, the present invention can also be applied to various kinds of apparatus for treating a substrate using a processing solution, such as a wet etching process as well as a cleaning process.

FIG. 1 is a cross-sectional view of a cleaning apparatus 10 according to an embodiment of the present invention. The cleaning apparatus 10 of FIG. 1 is a batch type cleaning apparatus in which the cleaning process may be performed on a plurality of wafers W. The cleaning process is performed in a state in which the wafers W are dipped into a cleaning solution contained in a cleaning chamber 100.

Referring to FIG. 1, the cleaning apparatus 10 includes the cleaning chamber 100, a support member 200, a cleaning solution supply member 300, and an electric-field forming member 400. The cleaning chamber 100 includes a container 120 and a cover 140. The container 100 has an opened upper portion and defines a space 122 to receive the wafers W, and the cover 140 opens/closes the upper portion of the container 120 and has a space 142 defined in a lower portion. The support member 200 for supporting the wafers W is disposed in the space 122 defined by the container 120, and the electric-field forming member 400 may be disposed in the space 142 defined by the cover 140 and activates the cleaning solution supplied to the cleaning chamber 100. A discharge pipe 124 is connected to the bottom of the container 120 and discharges the cleaning solution contained in the container 120 after the processes are completed. The cleaning solution discharged through the discharge pipe 124 can be collected and reused.

For simultaneously receiving a plurality of wafers W (about 50 wafers, for example), the support member 200 has support rods 220 with slots 222 into which an edge of each wafer W is inserted. Three support rods 220 may be arranged in parallel. The wafers W are inserted into the slots 222 so that they can be supported in an upright state by the support member 200.

The cleaning solution supply member 300 supplies the cleaning solution to the cleaning chamber 100. Deionized water may be used as the cleaning solution. The cleaning solution supply member 300 includes a nozzle 320 installed inside the cleaning chamber 100, and a cleaning solution supply pipe 340 for supplying the deionized water (as in this example) from the cleaning solution supply member 300 to the nozzle. A valve 342 is installed in the cleaning solution supply pipe 340. The valve 342 opens/closes an internal passage or controls a flow rate.

The nozzle 320 for spraying the deionized water and the electric-field forming member 400 for activating the deionized water are disposed inside the space 142 defined by the cover 140. The nozzle 320 is disposed at an upper portion of the space 142 and the electric-field forming member 400 may be disposed below the nozzle 320. The electric-field forming member 400 forms an electric field in a passage through which the deionized water flows to the container 120. Due to the electric field, water molecules are electrically dissociated into various active species. For example, when water molecules pass through the space 142 where the electric field is formed, the active species such as radicals (e.g., hydroxyl radicals, hydrogen radicals, oxygen radicals, and ozone radicals) as well as ions (hydroxyl ions, hydrogen ions, oxygen ions, and ozone ions) are generated from the water molecules. Among them, the hydroxyl radicals and the hydroxyl ions mainly participate in the overall wafer cleaning process. Specifically, the hydroxyl radicals have good reactivity compared with the hydroxyl ions. Therefore, the hydroxyl radicals are efficient at cleaning the wafer W.

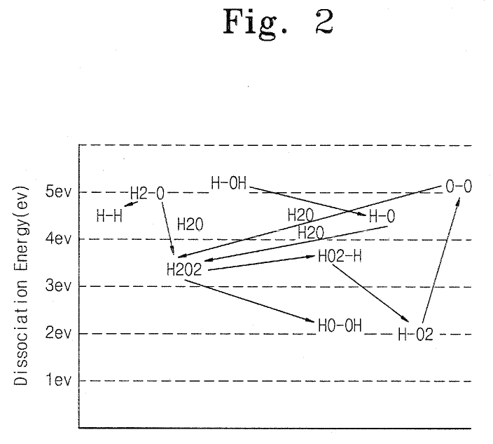

FIG. 2 is a graph illustrating the dissociation energy of molecules and the dissociation and combination of molecules. Referring to FIG. 2, when energy of about 5 eV is applied to a water molecule (H₂O), the water molecule dissociates into a hydrogen molecule and an oxygen ion. The oxygen ion may react with another water molecule to form hydrogen peroxide. If the hydrogen molecule receives additional energy of about 4.5 eV, it dissociates into hydrogen ions. Also, when the water molecule receives energy of about 5.2 eV, it dissociates into a hydrogen ion and a hydroxyl ion. The hydroxyl ion receives energy of about 4.5 eV and it dissociates into a hydrogen ion and an oxygen ion. That is, the energy of about 5 eV or more has to be applied for electrically dissociating the water molecule.

To activate the deionized water, the deionized water may be heated to very high temperature. However, when heated to a temperature of about 6000° C., the molecule can not obtain more than an energy of 0.5 eV. Therefore, an unreasonably high temperature is required to dissociate the water molecule by heating. However, if an electric field is formed in the passage through which the molecule flows, very high energy can be easily supplied to the water molecule at low temperature. Also, specific active species can be generated by changing the energy applied to the water molecule.

Of course, an electrolysis method can be used to activate the deionized water, generating hydrogen ions and hydroxyl ions as active species. But the kind and number of the active species are small compared with the method of activating the deionized water using the electric field. Also, the electrolysis method cannot generate active species with good reactivity, such as radicals.

Furthermore, when the active species are generated by dissolving a chemical solution in the deionized water, the active species contained in the cleaning solution are mainly ions. According to the present invention, however, when the active species are generated by flowing deionized water through a region where the electric field is formed, the active species contained in the deionized water include both ions and radicals and an amount of the active species is abundant. Therefore, the cleaning efficiency is excellent compared with the case of using the chemical solution. Also, contaminants can be removed from the wafer W without using the chemical solution. Consequently, environment pollution can be prevented and it is possible to reduce the cost spent due to the purchase and disposal of chemical solutions.

In addition, the active species can be generated by passing gas through the passage where the electric field is formed, and the generated active species can be dissolved in the cleaning solution and supplied to the cleaning chamber 100. In this case, however, much time is spent until the active species are supplied to the cleaning chamber 100, and thus the active species are subject to recombination. However, according to the present invention, the electric field is formed in the passage through which the deionized water is supplied to the container 120, and the active species are directly generated from the deionized water and then immediately supplied to the container 120. Therefore, the recombination of the active species can be minimized.

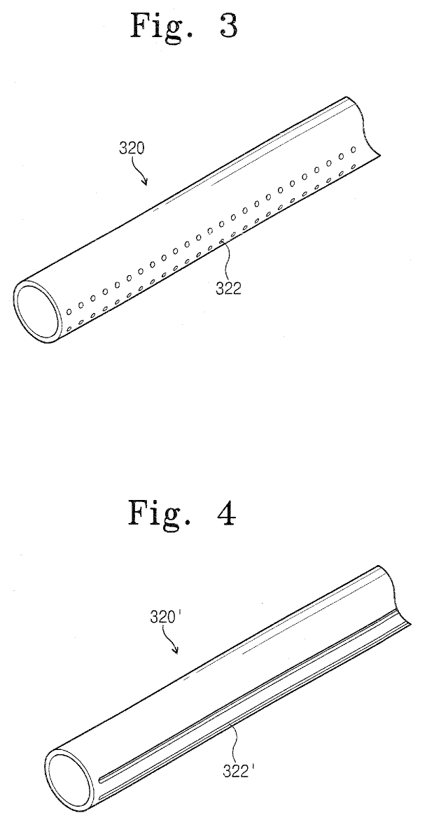

FIG. 3 is a perspective view of the nozzle 320 of FIG. 1. As shown in FIG. 1, two nozzles 320 are provided in parallel in the upper portion of the space 142 defined by the cover 140. The nozzles 320 have an elongated rod shape and have a plurality of spray holes 322 along their length direction. The spray holes 322 are arranged in one or more rows. Preferably, the spray holes 322 should have a small diameter so that the deionized water can be sprayed from the nozzle 320 in a mist state. When the deionized water passes through the space where the electric field is formed, the generation of the active species from the water molecules increases.

As illustrated in FIG. 4, the nozzle 320′ may also have a slit-shaped spray opening 322′. The number and shape of the nozzles 320 provided within the cover 140 may be changed.

Referring back to FIG. 1, the electric-field forming member 400 includes a first electrode 420, a second electrode 440, and a power source 460. The first electrode and the second electrode may have a plate shape and are arranged to face each other. The first electrode 420 is disposed above the second electrode 440, spaced apart from the second electrode 440 by a predetermined distance. The first electrode 420 and the second electrode 440 are formed of a metal such as copper. The power source 460 supplies a predetermined voltage to the first electrode 420 or the second electrode 440 to form an electric field between the first electrode 420 and the second electrode 440. For example, one of the first electrode 420 and the second electrode 440 is supplied with a high pulse voltage, and the other is grounded. Preferably, the predetermined voltage should be a pulse voltage of more than 1 kV.

The surfaces of the first electrode 420 and the second electrode 440 are coated with an insulating material. For example, the insulating material may be a silica (SiO₂) or an alumina (Al₂O₃). Then threshold voltage at which a spark is generated between the first electrode 420 and the second electrode 440 increases. Therefore, a large amount of the active species can be generated by increasing the intensity of the electric field formed between the first electrode 420 and the second electrode 440 without arcing. Also, since the electrodes 420 and 440 are not directly exposed to the deionized water, the generated active species will not be able to react with the electrodes 420 and 440, and thus the damage to the electrodes 420 and 440 can be prevented.

The first electrode 420 has a plurality of openings 426 to allow the deionized water sprayed from the nozzle 320 to be introduced into the space 402 where the electric field is formed. The second electrode 440 has a plurality of openings 446 to allow the activated deionized water to be discharged to the container 120. Preferably, the openings 426 of the first electrode 420 are formed to face the openings 446 of the second electrode 440. Positions of the openings 426 and 446 may be changed.

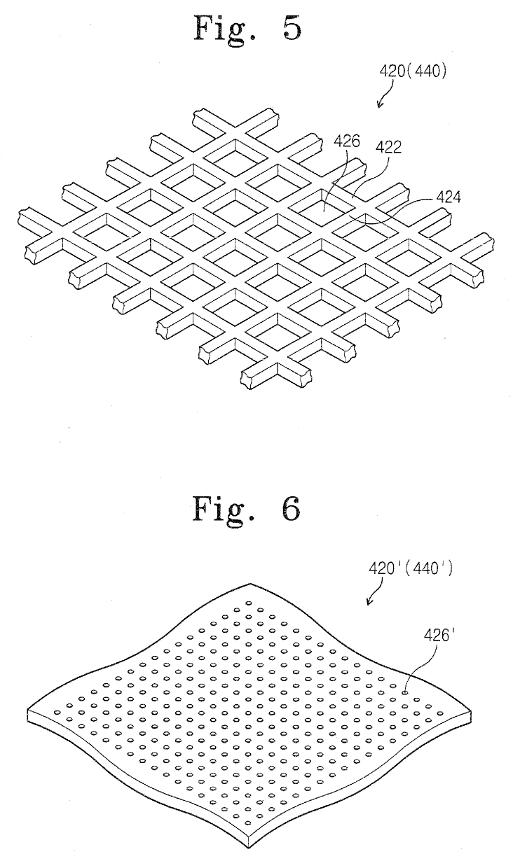

Referring to the embodiment of FIG. 5, the electrodes 420 and 440 are formed in a mesh shape. That is, the electrodes 420 and 440 include a plurality of first parts 422 arranged in parallel and a plurality of second parts 424 arranged in parallel, perpendicular to the first parts 422. The openings 426 and 446 are provided between the first parts 422 and the second parts 446.

FIG. 6 shows another embodiment. Here, the electrodes 420′ and 440′ have a porous plate shape. That is, a plurality of holes 426′ are formed in the electrodes 420′ and 440′.

Referring gain to FIG. 1, the deionized water in a mist state sprayed from the nozzle 320 is introduced into the space 402 between the first electrode 420 and the second electrode 440 through the openings of the first electrode 420. Water molecules of the deionized water in the space 402 where the electric field is formed are dissociated into various active species of ions and radicals. The deionized water containing the active species is supplied to the container 120 through the openings of the second electrode 440. If the traveling path of the active species to the container 120 is long, the active species may recombine before they are supplied to the container 120. However, according to the present invention, the active species are generated just before the deionized water is supplied to the container 120. Therefore, it is possible to prevent the active species from being recombined due to a long traveling path.

In addition, since the first electrode 420 and the second electrode 440 are formed in a plate shape, the electric field is formed over a wide area. Therefore, a large amount of deionized water can be activated in a short time, which is advantageous to a batch type cleaning apparatus requiring a large amount of the cleaning solution.

In this embodiment, the nozzle 320 is provided above the electric-field forming member 400, and the cleaning solution is sprayed from the nozzle 320 to the cover 140 in a mist state. Then, the cleaning solution is introduced between the first electrode 420 and the second electrode 440. However, the cleaning solution supply pipe 340 can also be directly connected to the first electrode 420 without any separate nozzle 320.

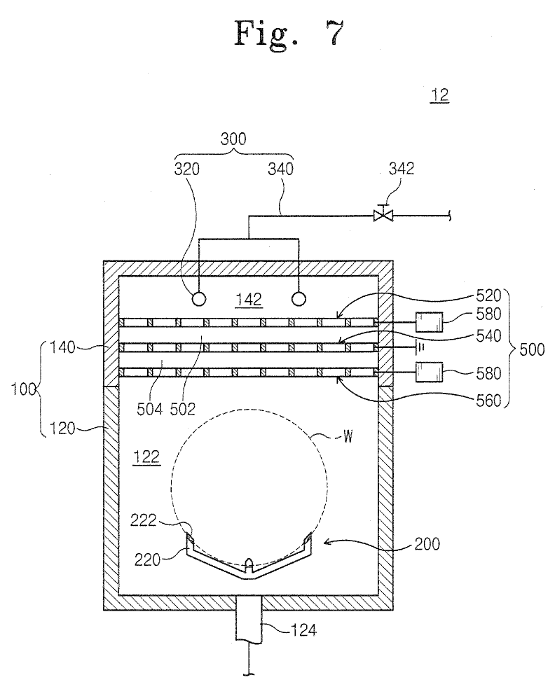

FIG. 7 is a cross-sectional view of a cleaning apparatus 12 according to another embodiment of the present invention. Referring to FIG. 7, an electric-field forming member 500 of the cleaning apparatus 12 includes a first electrode 520, a second electrode 540, and a third electrode 560. The electrodes 520, 540 and 560 can have the same shape as those 420 and 440 of FIG. 5 or 6, discussed earlier. The first to third electrodes 520, 540 and 560 are sequentially arranged downward in this order. The adjacent electrodes are spaced apart from one another by a predetermined distance so that the electric field is formed in the spaces 502 and 504. A power source 580 applies a predetermined voltage to the first to third electrodes 520, 540 and 560 so that the electric field is formed in the space 502 between the first electrode 520 and the second electrode 540 and in the space 504 between the second electrode 540 and the third electrode 560. For example, the second electrode 540 is grounded, and the first electrode 520 and the third electrode 560 are supplied with a high pulse voltage. Alternatively, the second electrode 540 is supplied with a high pulse voltage, and the first electrode 520 and the third electrode 560 are grounded. The deionized water sequentially passes through the space 502 between the first electrode 520 and the second electrode 540 and the space 504 between the second electrode 540 and the third electrode 560 and then is supplied into the container 120. Since the deionized water passes through the two spaces 502 and 504 where the electric field is formed, an amount of the active species can increase. Although the use of the three electrodes has been described in the above embodiment, it is apparent that more than three electrodes can be provided.

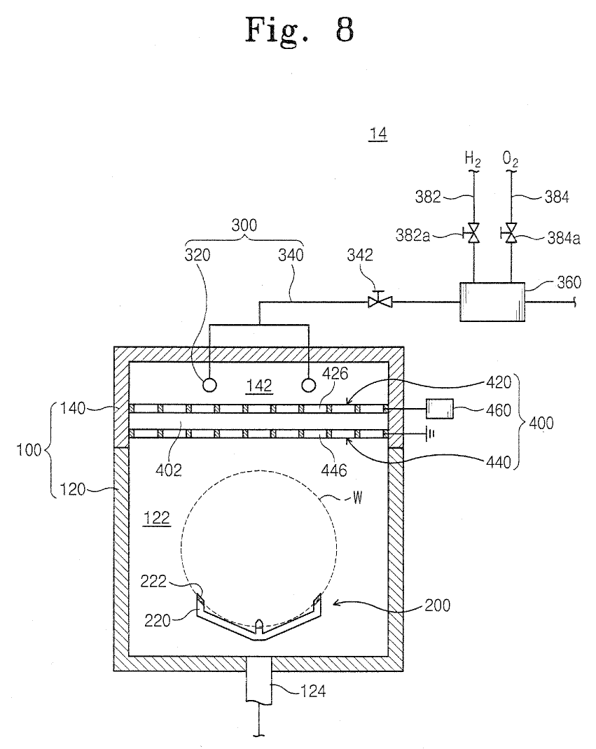

FIG. 8 is a cross-sectional view of a cleaning apparatus 14 according to a further embodiment of the present invention. Referring to FIG. 8, the cleaning apparatus 14 includes a mixing tank 360 in which a specific gas is dissolved in the deionized water before the deionized water is supplied to a region where the electric field is formed. The mixing tank 360 is installed in a cleaning solution supply pipe 340, and gas supply pipes 382 and 384 are connected to the mixing tank 360. Gases are used that can generate active species that react well with the contaminants to be removed from the wafer W. For example, when the contaminants are organic matter, oxygen gas (O₂) is supplied to the mixing tank 360 so that oxygen ions and oxygen radicals, and ozone ions and ozone radicals can be generated. When the contaminants are particles or metal, hydrogen gas (H₂) is supplied to the mixing tank 360 so that hydrogen ions and hydrogen radicals can be generated. An oxygen supply pipe 382 for supplying oxygen gas and a hydrogen supply pipe 384 for supplying hydrogen gas may be connected to the mixing tank 360, and valves 382a and 384a for opening/closing internal passages and controlling a flow rate may be installed in the supply pipes 382 and 384, respectively. Alternatively, the oxygen supply pipe 382 and the hydrogen supply pipe 384 may be directly connected to the space defined by the cover 140, without providing the mixing tank 360.

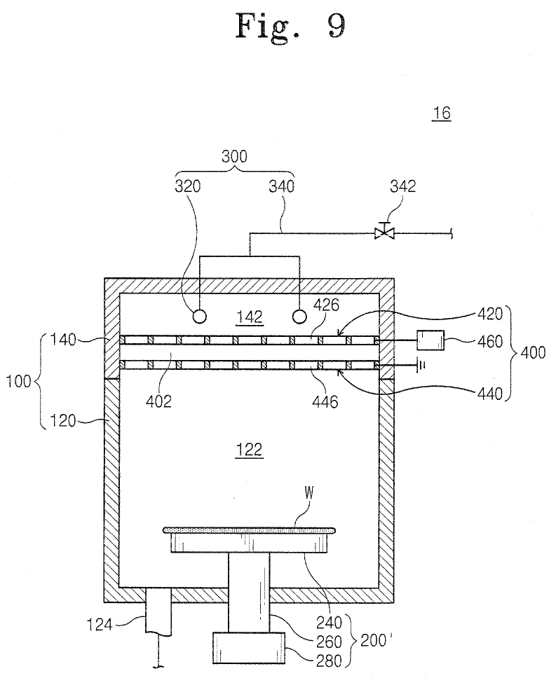

FIG. 9 is a cross-sectional view of a cleaning apparatus 16 according to a further embodiment of the present invention. The cleaning apparatus 16 of FIG. 9 is a single wafer type cleaning apparatus in which a cleaning process is performed with respect to one wafer W by directly spraying a cleaning solution on the wafer W. Referring to FIG. 9, the cleaning apparatus 16 includes a cleaning chamber 100, a support member 200′, a cleaning solution supply member 300, and an electric-field forming member 400. Since the structures of the cleaning chamber 100, the cleaning solution supply member 300, and the electric-field forming member 400 are similar to those of FIG. 1, a detailed description thereof will be omitted.

In this embodiment, the support member 200′ includes a support plate 240 and a support shaft 260. The support plate 240 has a flat disc shape and has a diameter similar to that of the wafer W. The wafer W may be placed on the support plate 240 so that a surface to be processed faces upward. The support shaft 260 is connected to the bottom of the support plate 240. During the processes, the support shaft 260 is rotated by a driver 280, such as a motor. Also, the support plate 240 can support the wafer W by means of a vacuum or mechanical clamping.

The second electrode 440 can be formed so that the discharge openings of the deionized water are uniformly arranged in the entire second electrode 440. Alternatively, the second electrode 440 can be formed differently depending on sizes and intervals of the openings, so that an amount of the deionized water is supplied differently depending on the region of the wafer W. For example, the openings of the second electrode 440 can be formed so that a large amount of the cleaning solution is supplied to the central portion of the wafer W, while a small amount of the cleaning solution is supplied to the edge portion of the wafer W.

Although the above description has been made about the electrodes arranged to face one another in a horizontal direction, the electrodes can also be arranged to face one another in a vertical, or any other, direction.

A method of cleaning the wafer W will be described below.

The method of cleaning the wafer W includes removing contaminants.

The cleaning method includes removing contaminants (e.g., metallic contaminants, particles, and organic matter) from the wafer W by using the activated deionized water, and drying the wafer W. Specifically, the deionized water is sprayed in a mist state into the space 142 defined by the cover 140. The deionized water is introduced in the region where the electric field is formed and then is activated. The deionized water is supplied until the activated deionized water reaches a predetermined height in the container 120. The cover 140 is opened so that the container 120 is opened. Wafers W are placed in the support member 200 by a transport robot and are dipped in the deionized water. Contaminants (e.g., metallic contaminants, particles, and organic matter) are removed from the wafer W by the active species such as the ions and radicals contained in the deionized water.

Oxygen gas (O₂) or hydrogen gas (H₂) may be dissolved in the deionized water so as to allow for a large amount of specific active species contained in the deionized water, depending on the kinds of the contaminants to be removed from the wafer W. For example, when the contaminants intended to be removed from the wafer W are mainly organic matter, it is oxygen gas (O₂) that is dissolved in the deionized water. When the contaminants are mainly particles or metal, it is hydrogen gas (H₂) that is dissolved in the deionized water. Preferably, the dissolution of gas should be achieved before the deionized water passes through the region where the electric field is formed.

When the cleaning process using the deionized water containing the active species is completed, the wafer W is dried. The drying of the wafer W may be achieved by various methods. The wafer W can be dried using a centrifugal force, a marangoni principle, an azeotropic effect, an isopropyl alcohol vapor, a heated nitrogen gas, and so on.

The general cleaning of the wafer W includes a chemical-solution treatment process of removing contaminants from the wafer W by using a chemical solution, a rinsing process of removing a remaining chemical solution from the wafer W by using deionized water, and a drying process of removing the deionized water from the wafer W. According to the cleaning method of the present invention, the removal of the contaminants from the wafer W is achieved by the deionized water containing a large amount of active species. Therefore, the process of rinsing the wafer W is unnecessary. Consequently, time necessary for the cleaning process can be remarkably reduced. Also, since the deionized water is activated by electric energy, the active species participating in the cleaning process include radicals with very excellent reactivity, as well as ions. Therefore, compared with the conventional cleaning method, the cleaning efficiency is very high. Further, the environment pollution due to the use of the chemical solution can be prevented.

In the above-described embodiment, the cleaning of the wafer W is achieved without the rinsing process. Alternatively, before drying the wafer W, a process of rinsing the wafer W using the cleaning solution such as the deionized water may be further included.

In another embodiment, the cleaning process includes removing contaminants from the wafer W by using a chemical solution, rinsing the wafer W by using the activated deionized water, and drying the wafer W. The deionized water in which hydrogen (H₂) is dissolved so that the deionized water can contain a large amount of hydrogen radical can be provided to the region where the electric field is formed. Since the method of activating the deionized water is identical to that of the above-described embodiment, a detailed description thereof will be omitted.

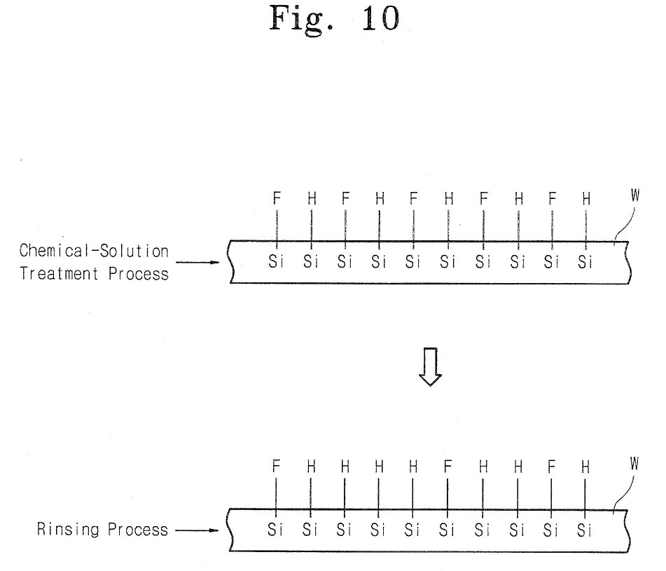

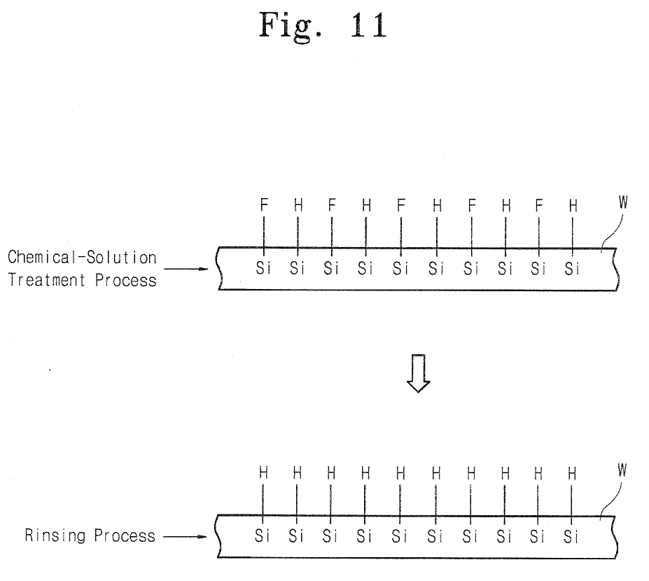

FIG. 10 illustrates a surface state of the wafer W during the cleaning process using the general deionized water, and FIG. 11 illustrates an improved surface state of the wafer W during the cleaning process using the deionized water containing radicals, as in the invention.

Referring to FIG. 10, when the chemical-solution treatment process is performed on a bare wafer by using a fluoric acid, fluorine and hydrogen are mainly combined on the surface of the wafer W. Then, fluorine is replaced with hydrogen on the surface of the wafer W by the rinsing process using the deionized water. However, since the replacement is achieved by hydrogen ions, the replacement rate is low and thus a large amount of fluorine is combined on the surface of the wafer W even after the rinsing process. Due to fluorine combined on the surface of the wafer W, a natural oxide layer is easily formed when the wafer W is exposed to oxygen.

Referred to FIG. 11, however, if the wafer W chemically processed by the fluoric acid is rinsed using the deionized water containing hydrogen radicals, most of the fluorine combined on the surface of the wafer W is replaced with hydrogen due to the excellent reactivity of the hydrogen radical. Therefore, even if the wafer W is exposed to oxygen, it is possible to prevent the formation of the natural oxide layer on the wafer W.

The following Table 1 shows the comparison of the number of hydrogen combined on the surface of the bare wafer when the bare wafer is rinsed using the deionized water containing no radicals and when the bare wafer is rinsed using the deionized water containing the radicals. The number of silicon-hydrogen (Si—H) combination was measured using variation of wavelengths absorbed by the Si—H combinations when infrared rays are irradiated on the surface of the wafer W.

TABLE 1

| | Deionized water containing | |
|---|---|---|
| | radicals | Deionized water |
| Si—H combination | 0.016 | 0.009 |
| (relative magnitude) | | |

As can be seen from Table 1, the number of Si—H combination on the surface of the wafer when the bare wafer is rinsed using the deionized water containing the radicals is about 1.8 times the number of Si—H combination on the surface of the wafer when the bare wafer is rinsed using the deionized water containing no radicals.

According to the present invention, since contaminants are removed from the wafer by using the active species generated from the deionized water, environment pollution caused by the use of chemical solution can be prevented, and it is possible to reduce the cost spent due to the purchase and disposal of chemical solutions. Also, the rinsing process inevitably required when the chemical solution is used can be omitted. Consequently, time necessary for the various processes can be reduced.

In addition, since the deionized water is activated by making it flow through the region where the electric field is formed, a large amount of radicals with excellent reactivity, as well as ions, is generated, thereby remarkably improving the cleaning efficiency.

Further, since the electric field is directly formed within the cleaning solution supply pipe, the deionized water is activated while being supplied to the cleaning chamber. Therefore, it is possible to minimize the recombination of the active species before the active species are supplied to the cleaning chamber.

Furthermore, since the electric field is formed in a wide area by the use of the plate-shaped electrodes, a large amount of the cleaning solution can be simultaneously activated. Therefore, the present invention is very advantageous to a batch type cleaning apparatus requiring a large amount of the cleaning solution.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for treating a substrate, comprising:
a processing chamber including a container adapted to receive at least one substrate;
a processing solution supply pipe coupled to the processing chamber; and
an electric-field forming member installed in the processing chamber to activate a processing solution supplied by the supply pipe to form an activated processing solution,
wherein the electric-field forming member includes:
a plurality of electrodes spaced apart from one another to thereby define a space into which the processing solution is introduced; and
a power source for applying a predetermined voltage to at least one of the electrodes to form an electric field in the space between the adjacent electrodes.

2. The apparatus of claim 1, wherein the apparatus is an apparatus for cleaning a substrate, and the processing solution is a cleaning solution.

3. The apparatus of claim 2, wherein the cleaning solution is deionized water.

4. The apparatus of claim 3, further comprising a mixer installed in the processing solution supply pipe to dissolve hydrogen (H₂) and oxygen (O₂) into the deionized water.

5. The apparatus of claim 1, wherein the electrodes are arranged in a horizontal direction.

6. The apparatus of claim 1, wherein the electrodes have a plate shape.

7. The apparatus of claim 1, wherein the electric-field forming member comprises:
a first electrode; and
a second electrode disposed below the first electrode, so that the second electrode faces the first electrode.

8. The apparatus of claim 7, further comprising a nozzle for spraying the processing solution toward the first electrode, the processing solution being supplied from the processing solution supply pipe, wherein the first electrode includes a plurality of openings through which the processing solution sprayed from the nozzle is introduced to the space, and the second electrode includes a plurality of openings through which the activated processing solution is discharged to the container.

9. The apparatus of claim 8, wherein the first electrode and the second electrode are formed in a mesh shape.

10. The apparatus of claim 8, wherein the first electrode and the second electrode are formed in a porous plate shape.

11. The apparatus of claim 10, wherein the nozzle has a spray hole to supply the processing solution in a mist state.

12. The apparatus of claim 10, wherein the nozzle has a slit to supply the processing solution in a mist state.

13. The apparatus of claim 1, wherein surfaces of the electrodes are coated with an insulating material.

14. The apparatus of claim 7, wherein the processing chamber further comprises a cover for opening/closing the opened upper portion of the container and the electric-field forming member is disposed in the cover.

15. The apparatus of claim 7, further comprising a plurality of support members disposed in the container, the plurality of support members having slots into which an edge of a wafer is inserted.

16. The apparatus of claim 7, wherein the first electrode is supplied with a pulse voltage and the second electrode is grounded.

17. The apparatus of claim 7, wherein the electric-field forming member further comprises a third electrode facing the first electrode, the third electrode being spaced apart from the second electrode by a predetermined distance forming a second space, and a power source adapted to apply a predetermined voltage to the second electrode or the third electrode to form an electric field between the second electrode and the third electrode.

18. The apparatus of claim 1, further comprising a rotatable support plate adapted to securely hold the substrate in the container.

19. A method for treating a substrate within a container, comprising:
passing a processing solution through a first electrode into a space formed between the first electrode and a second electrode, wherein an electric field is applied within the space;
activating the processing solution within the space to form an activated processing solution;
passing the activated processing solution through the second electrode; and
applying the activated processing solution to the substrate.

20. The method of claim 19, further comprising immersing a plurality of substrates in the container storing the activated processing solution.

21. The method of claim 19, wherein applying the activated processing solution to the substrate is a cleaning process and the processing solution is deionized water.

22. The method of claim 21, wherein the cleaning process includes removing at least one of metallic contaminants, particles, and organic matter from the substrate.

23. The method of claim 21, further comprising drying the substrate without a rinsing process after the cleaning process using the activated cleaning solution.

24. The method of claim 21, further comprising dissolving at least one of hydrogen (H₂) and oxygen (O₂) in the deionized water before activating the deionized water.

25. The method of claim 21, wherein the cleaning process includes rinsing the substrate from which contaminants are removed by a chemical solution.

26. The method of claim 19, further comprising:
passing the processing solution through the second electrode into a second space formed between the second electrode and a third electrode, wherein an electric field is applied within the second space;
further activating the processing solution within the second space; and
passing the activated processing solution through the third electrode.
